(19) United States
(12) Patent Application Publication
(10) Pub. No.: US 2013/0183469 A1
(43) Pub. Date: Jul. 18, 2013

(54) RESIN SHEET FOR HOLLOW ENCAPSULATION AND PRODUCTION METHOD FOR THE SHEET, AND PRODUCTION METHOD FOR HOLLOW ELECTRONIC PART APPARATUS AND HOLLOW ELECTRONIC PART APPARATUS

(71) Applicant: Nitto Denko Corporation, Osaka (JP)

(72) Inventors: Yusaku SHIMIZU, Ibaraki-shi (JP); Eiji TOYODA, Ibaraki-shi (JP); Takeshi MATSUMURA, Ibaraki-shi (JP)

(73) Assignee: NITTO DENKO CORPORATION, Osaka (JP)

(21) Appl. No.: 13/740,757

(22) Filed: Jan. 14, 2013

(30) Foreign Application Priority Data
Jan. 16, 2012 (JP) 2012-006277

(51) Int. Cl. B32B 1/02; B32B 3/30

(52) U.S. Cl. CPC B32B 1/02; B32B 3/30
USPC 428/36.92; 264/320; 156/242; 156/250

(57) ABSTRACT

A resin sheet is provided for hollow encapsulation excellent in productivity, and excellent in resin strength and heat resistance as well. The resin sheet for hollow encapsulation to be used for subjecting electronic parts mounted on an aggregate substrate to hollow encapsulation includes an epoxy resin composition containing the following components (A) to (D), in which the resin sheet for hollow encapsulation has, in one surface of a sheet main body, a plurality of cavities for storing the electronic parts to subject the parts to hollow encapsulation: (A) an epoxy resin; (B) a curing agent; (C) an inorganic filler; and (D) a curing accelerator.

### BACKGROUND OF THE INVENTION

1. Field of the Invention

The present invention relates to a resin sheet for hollow encapsulation having a plurality of cavities (recesses) for subjecting, for example, micro electro mechanical systems (MEMS) to hollow encapsulation and a production method for the sheet, and a production method for a hollow electronic part apparatus and a hollow electronic part apparatus (hereinafter, sometimes referred to as “hollow package” or “hollow device”) obtained by the method.

2. Description of the Related Art

In general, when electronic parts such as solid-state imaging devices, e.g., an image sensor and various sensors are to be mounted, a space needs to be provided above such devices or sensors in order that the properties of the devices or sensors may not be impaired. Capping with a metal has heretofore been performed as a method of providing the space (see Japanese Patent No. 4,189,970 and JP-A-2008-60289). A method involving forming a photosensitive adhesive as a gap through an exposure or development treatment to provide the space has also been performed (see JP-A-2009-263544).

However, such capping with a metal, as described in Japanese Patent No. 4,189,970 or JP-A-2008-60289, is poor in productivity because of the following reasons. Upon its bonding to a substrate, the cap needs to be joined while being overlaid on electronic parts individually. In addition, a special joining method such as the application of an adhesive or welding is needed. Meanwhile, as described in JP-A-2009-263544, with regard to the method involving using the photosensitive adhesive as a gap, it is difficult to add a filler from the viewpoint of curing with light. Accordingly, peeling or cracking caused by a stress is liable to occur owing to a difference in linear expansion coefficient, thereby leading to a poor resin strength or poor heat resistance. In addition, the method requires a step such as an exposure or development treatment in the production of a package, and hence the number of its steps increases.

### SUMMARY OF THE INVENTION

A resin sheet is provided for hollow encapsulation excellent in productivity, and excellent in resin strength and heat resistance as well. A production method for the sheet, and a production method for a hollow electronic part apparatus and a hollow electronic part apparatus obtained by the method are also provided.

A resin sheet for hollow encapsulation has, in one surface of a sheet main body formed of a resin composition containing a resin, a curing agent, an inorganic filler, and a curing accelerator, a plurality of cavities (recesses) for storing the electronic parts to subject the parts to hollow encapsulation. It is particularly effective to use an epoxy resin composition.

That is, a first gist resides in a resin sheet for hollow encapsulation to be used for subjecting electronic parts mounted on an aggregate substrate to hollow encapsulation, the resin sheet for hollow encapsulation including an epoxy resin composition containing the following components (A) to (D), in which the resin sheet for hollow encapsulation has, in one surface of a sheet main body, a plurality of cavities for storing the electronic parts to subject the parts to hollow encapsulation:
(A) an epoxy resin;
(B) a curing agent;
(C) an inorganic filler; and
(D) a curing accelerator.

In addition, a second gist resides in a production method for the resin sheet for hollow encapsulation, the method including: preparing a flat-plate resin sheet formed of an epoxy resin composition containing the components (A) to (D); and pressing the flat-plate resin sheet with a die having a convex structure for the cavities with one of a press and a laminator.

Further, a third gist resides in a production method for the resin sheet for hollow encapsulation, the method including: preparing each of a flat-plate resin sheet formed of an epoxy resin composition containing the components (A) to (D), and a flat-plate resin sheet formed of an epoxy resin composition containing the components (A) to (D) and having hole portions for the plurality of cavities; and attaching both the resin sheets to each other.

In addition, a fourth gist resides in a production method for a hollow electronic part apparatus, the method including: bonding the resin sheet for hollow encapsulation to an aggregate substrate having electronic parts mounted on a surface thereof in a state where the electronic parts are stored in corresponding cavities; curing the sheet; and dicing the resultant into individual pieces including the electronic parts. Further, a fifth gist is a hollow electronic part apparatus, which is obtained by the production method for a hollow electronic part apparatus.

As described above, the resin sheet for hollow encapsulation is formed of the epoxy resin composition containing the epoxy resin (component (A)), the curing agent (component (B)), the inorganic filler (component (C)), and the curing accelerator (component (D)), and the resin sheet for hollow encapsulation has, in one surface of the sheet main body, a plurality of cavities for storing the electronic parts to subject the parts to hollow encapsulation. The use of such resin sheet for hollow encapsulation provides excellent productivity (mass productivity) because the use enables collective hollow encapsulation of a plurality of electronic parts mounted on an aggregate substrate in the production of a hollow electronic part apparatus. In addition, the resin sheet for hollow encapsulation shows a reduced difference in linear expansion coefficient because the sheet contains the inorganic filler (component (C)) as well as the epoxy resin (component (A)). Accordingly, its peeling or cracking caused by a stress hardly occurs, and hence its resin strength and heat resistance improve.

In addition, when the content of the inorganic filler (component (C)) is 70 to 93 wt % of an entirety of the epoxy resin composition, a reduction in linear expansion coefficient of the resin after it s curing can be suppressed, and hence the resin strength and heat resistance additionally improve.

### BRIEF DESCRIPTION OF THE DRAWINGS

FIG. 1 is a perspective view illustrating a resin sheet for hollow encapsulation;

FIG. 2 is a sectional view illustrating the resin sheet for hollow encapsulation;

FIG. 3 is an explanatory diagram illustrating a production method for the resin sheet for hollow encapsulation (lamination method);

FIG. 4 is an explanatory diagram illustrating a production method for the resin sheet for hollow encapsulation (pressing method);

FIG. 5 is an explanatory diagram illustrating a production method for the resin sheet for hollow encapsulation (stacking method);

FIG. 6 is an explanatory diagram illustrating the production method for the resin sheet for hollow encapsulation (stacking method);

FIG. 7 is an explanatory diagram illustrating a production method for a hollow electronic part apparatus; and

FIG. 8 is an explanatory diagram illustrating the production method for a hollow electronic part apparatus.

### DETAILED DESCRIPTION OF THE INVENTION

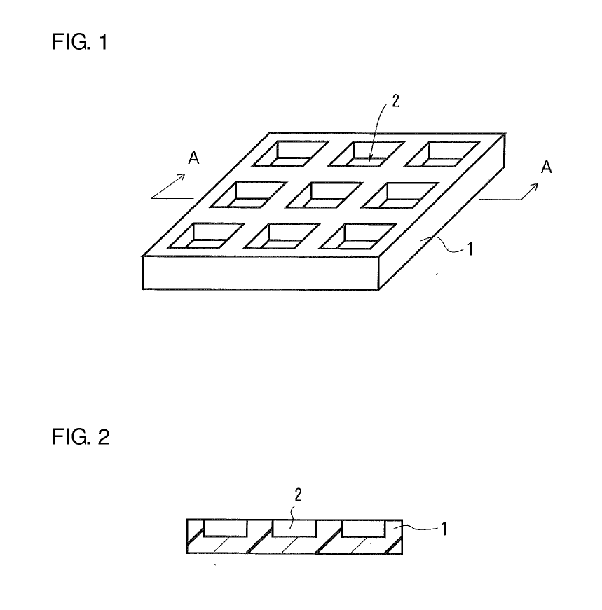

FIG. 1 is a perspective view illustrating a resin sheet for hollow encapsulation and FIG. 2 is a sectional view taken along the line A-A of the resin sheet for hollow encapsulation of FIG. 1. The resin sheet for hollow encapsulation is used for collective hollow encapsulation of electronic parts mounted on an aggregate substrate, and as illustrated in, for example, FIG. 1 and FIG. 2, a plurality of (nine in FIG. 1) cavities (recesses) 2 for subjecting the electronic parts (not shown) to hollow encapsulation are formed in one surface of a sheet main body 1 formed of an epoxy resin composition.

The resin sheet for hollow encapsulation includes an epoxy resin composition containing the following components (A) to (D):
(A) an epoxy resin;
(B) a curing agent;
(C) an inorganic filler; and
(D) a curing accelerator.

First, each component of the epoxy resin composition is described.

<<Epoxy Resin (Component A)>>

Examples of the epoxy resin (component A) include a cresol novolac type epoxy resin, a bisphenol A type epoxy resin, a bisphenol F type epoxy resin, a biphenyl type epoxy resin, a naphthol type epoxy resin, a triphenolmethane type epoxy resin, and a dicyclopentadiene-modified phenol type epoxy resin. One kind of those epoxy resins is used alone, or two or more kinds thereof are used in combination.

<<Curing Agent (Component B)>>

Examples of the curing agent (component B) include a phenol resin, an acid anhydride-based compound, and an amine-based compound. One kind of those curing agents is used alone, or two or more kinds thereof are used in combination. Of those, a phenol resin is preferred.

Examples of the phenol resin include a phenol novolac resin, a phenol aralkyl resin, a biphenyl aralkyl resin (phenol resin having a biphenyl aralkyl skeleton), a dicyclopentadiene type phenol resin, a cresol novolac resin, and a resol resin.

When the phenol resin is used as the curing agent (component B), the phenol resin is added so that the number of equivalents of the hydroxyl groups of the phenol resin may be typically 0.5 to 2 equivalents, preferably 0.8 to 1.2 equivalents with respect to 1 equivalent of epoxy groups in the epoxy resin (component A).

<<Inorganic Filler (Component C)>>

Examples of the inorganic filler (component C) include powders of quartz glass, talc, silica (such as molten silica or crystalline silica), alumina, aluminum nitride, silicon nitride, calcium carbonate (such as heavy calcium carbonate, light calcium carbonate, or Hakuenka), and titanium oxide. One kind of those inorganic fillers is used alone, or two or more kinds thereof are used in combination. Of those, silica powders are preferred in consideration of a reduction in linear expansion coefficient of the resin after its curing, and a molten silica powder is particularly preferred.

Examples of the molten silica powder include a spherical molten silica powder and a crushed molten silica powder. Of those, a spherical molten silica powder is preferably used in consideration of the flowability of a kneaded product.

The content of the inorganic filler (component C) is typically 50 to 95 wt % of the entirety of the epoxy resin composition, and in consideration of the reduction in linear expansion coefficient of the resin after the curing, the content is preferably 70 to 93 wt %.

<<Curing Accelerator (Component D)>>

Examples of the curing accelerator (component D) include: an organophosphorus compound such as triphenylphosphine or tetraphenylphosphonium tetraphenylborate; and an imidazole-based compound. One kind of those curing accelerators is used alone, or two or more kinds thereof are used in combination.

The content of the curing accelerator (component D) is preferably 0.05 to 3.5 wt %, particularly preferably 0.1 to 2 wt % of the entirety of the epoxy resin composition.

The epoxy resin composition to be used may be blended with an elastomer component in consideration of an improvement in viscosity at the time of its high-temperature curing for the maintenance of the hollow structures of the cavities 2.

The elastomer component is preferably a component that thickens the resin, and examples thereof include an acrylic copolymer, an elastomer having a styrene skeleton, and a rubber-like polymer. One kind of those components is used alone, or two or more kinds thereof are used in combination.

Examples of the acrylic copolymer include a polyacrylic acid ester. Examples of the elastomer having a styrene skeleton include a polystyrene-polyisobutylene-based copolymer and a styrene acrylate-based copolymer. Examples of the rubber-like polymer include a butadiene rubber, a styrene-butadiene rubber (SBR), an ethylene-vinyl acetate copolymer (EVA), an isoprene rubber, and an acrylonitrile rubber.

The content of the elastomer component is preferably 0.1 to 25 wt %, particularly preferably 0.3 to 15 wt % of the entirety of the epoxy resin composition.

It should be noted that a known additive such as a flame retardant or a pigment, e.g., carbon black can be added at an appropriate ratio to the epoxy resin composition in addition to the components A to D.

The epoxy resin composition can be produced, for example, as described below. The components A to D are blended and the elastomer component is blended in some cases. Further, the various additives to be blended as required are appropriately blended, followed by kneading with a kneader.

Next, the resin sheet for hollow encapsulation is described.

The resin sheet for hollow encapsulation can be produced with the epoxy resin composition by, for example, a method described in any one of the following production methods 1 to 3.

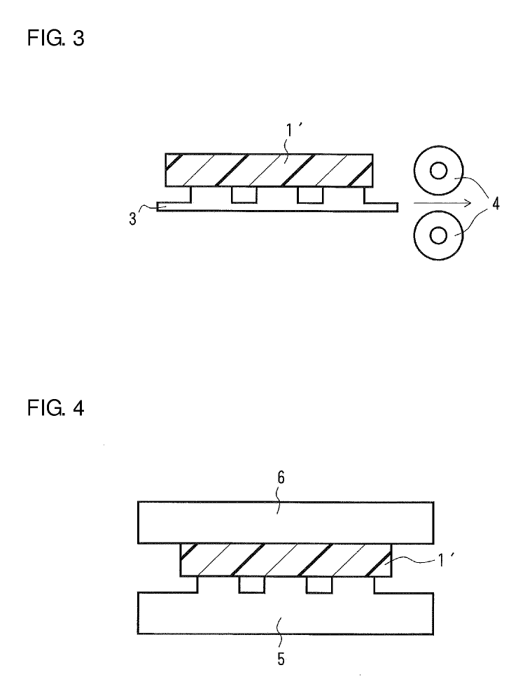

(Production Method 1 (Lamination Method) (See FIG. 3))

The epoxy resin composition is pressed with a pressing machine to produce a flat-plate resin sheet 1′, the flat-plate resin sheet 1′ is superimposed on a die 3 having a convex structure for the cavities 2, and the resultant is pressed with a laminator 4 as indicated by an arrow illustrated in the figure (see FIG. 3). Thus, the resin sheet for hollow encapsulation having the plurality of cavities 2 formed in one surface of the sheet main body 1 can be produced (see FIGS. 1 and 2). It should be noted that a film may be interposed between the flat-plate resin sheet 1′ of FIG. 3 and the die 3 having the convex structure in terms of releasability.

(Production Method 2 (Pressing Method) (See FIG. 4))

The epoxy resin composition is pressed with a pressing machine to produce the flat-plate resin sheet 1′, and then the flat-plate resin sheet 1′ is interposed and pressed between a lower die 5 having a convex structure for the cavities 2 and a flat-plate upper die 6 (see FIG. 4), followed by its removal from the dies. Thus, the resin sheet for hollow encapsulation having the plurality of cavities 2 formed in one surface of the sheet main body 1 can be produced (see FIGS. 1 and 2). It should be noted that a film may be interposed between the flat-plate resin sheet 1′ of FIG. 4 and each of the lower die 5 and the upper die 6 in terms of releasability.

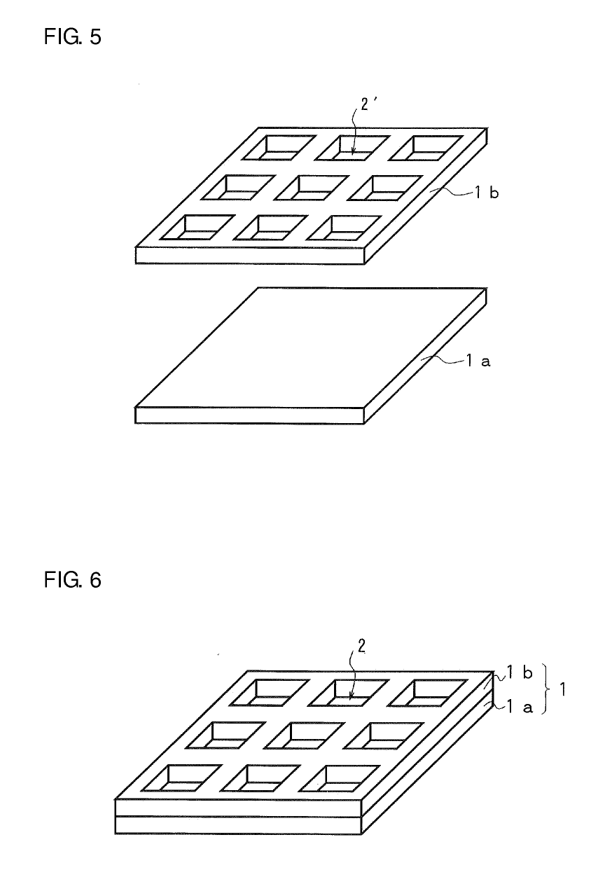

(Production Method 3 (Stacking Method) (See FIGS. 5 and 6))

First, the epoxy resin composition is pressed with a pressing machine to produce a flat-plate resin sheet la. Next, a flat-plate resin sheet produced in the same manner as in the flat-plate resin sheet 1a is subjected to hole processing by means of punching, a Thomson press, or the like to produce a flat-plate resin sheet 1b having angular hole portions 2′ for the plurality of cavities 2 (to serve as the cavities 2 after stacking) (see FIG. 5). The flat-plate resin sheet 1a is attached to the sheet 1b. Thus, the resin sheet for hollow encapsulation having the plurality of cavities 2 formed in one surface of the sheet main body 1 formed of the resin sheets 1a and 1b can be produced (see FIG. 6).

With regard to conditions for the pressing in the production method 1 (lamination method) or the production method 2 (pressing method), in consideration of the loading of the resin into an edge portion, it is preferred that a pressure of 0.5 kg/cm² or more be applied in such a temperature region that the resin viscosity of the epoxy resin composition becomes less than 200 Pa·s.

The resin viscosity refers to a value measured with a viscoelasticity-measuring apparatus ARES manufactured by TA instruments (measurement conditions: a measurement temperature range of 40 to 175° C., a rate of temperature increase of 10° C./min, and a frequency of 1 Hz).

In addition, in the production method 3 (stacking method), in consideration of the deformation of a gap portion, the resin sheets 1a and 1b are preferably attached to each other in such a temperature region that the resin viscosity becomes 5,000 Pa·s or more, or the sheets are preferably attached to each other while the amount of compression is set to 50 μm or less by GAP adjustment.

Although only the method involving pressing the epoxy resin composition obtained by kneading the respective components to produce the flat-plate resin sheet (1′, 1a) has been described in each of the production methods 1 to 3, the present invention is not limited to this method and the sheet can be produced by, for example, varnish coating. That is, the flat-plate resin sheet (1′, 1a) may be produced as described below. The components A to D are blended and the elastomer component is blended in some cases. Further, the various additives to be blended as required are appropriately dissolved or dispersed in the mixture to prepare a varnish. Next, the varnish is applied to a base material such as a polyester film and then dried.

The thickness of the resin sheet for hollow encapsulation is typically 0.1 to 1.5 mm, preferably 0.3 to 1 mm. The size of the resin sheet for hollow encapsulation, the number of the cavities 2, the depth of each of the cavities 2, and the like are appropriately selected depending on an electronic part to be encapsulated.

It should be noted that the shape of each of the cavities 2 in the resin sheet for hollow encapsulation can be appropriately changed depending on, for example, the shape of an aggregate substrate to be used (crimped). For example, when an aggregate substrate formed only of electronic parts that require hollow encapsulation such as MEMS and a surface acoustic wave (SAW) filter is used, all of (nine in FIG. 1) the cavities 2 are of hollow shapes. When a hybrid substrate in which electronic parts that require hollow encapsulation such as MEMS and electronic parts that require general resin encapsulation except the MEMS and the like are simultaneously present is used, the cavities 2 corresponding to the electronic parts that require resin encapsulation can be filled with a resin in advance.

Next, a hollow electronic part apparatus is described.

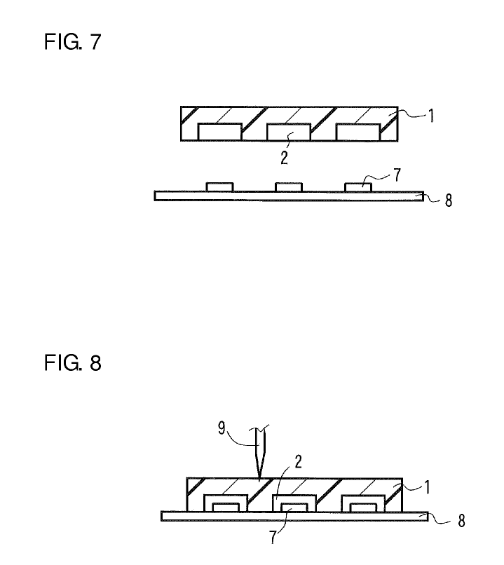

The hollow electronic part apparatus can be produced by, for example, bonding the resin sheet for hollow encapsulation to an aggregate substrate 8 having electronic parts 7 mounted on its surface (see FIG. 7) in a state where the electronic parts 7 are stored in the corresponding cavities 2, curing the sheet, and dicing the resultant with a dicing blade 9 into individual pieces including the electronic parts 7 (see FIG. 8). It should be noted that when the hybrid substrate is used, the dicing into individual pieces has only to be performed as required.

With regard to a heating or crimping condition, such a heating condition that the resin viscosity at the time of the crimping becomes 5,000 Pa·s or more, or such a crimping condition that the amount of compression becomes 50 μm or less is preferred. In addition, from the viewpoint of maintaining the hollow structures at the time of the thermal curing, a resin composition whose resin has a lowest melt viscosity of 10 to 10,000 Pa·s is preferably used, and a resin composition whose resin has a lowest melt viscosity of 20 to 5,000 Pa·s is particularly preferred.

The lowest melt viscosity means the lowest viscosity value upon tracking of a viscosity change with a viscoelasticity-measuring apparatus ARES manufactured by TA instruments (measurement conditions: a measurement temperature range of 40 to 175° C., a rate of temperature increase of 10° C./min, and a frequency of 1 Hz).

It should be noted that when the lowest melt viscosity of the resin is less than 5,000 Pa·s, a cover film may be used as a supporting layer at the time of the curing. Examples of the kind of the supporting layer include a polyethylene, a polypropylene, a polyamide, a polyimide, an aramid fiber, a glass cloth, a polyvinyl chloride, and a metal foil.

In addition, when the lowest melt viscosity of the resin is 5,000 Pa·s or more, an adhesion layer may be provided between the resin sheet for hollow encapsulation and the aggregate substrate in consideration of a reduction in adhesive force after the curing. A material for the formation of the adhesion layer is preferably a thermosetting resin having a lowest melt viscosity of less than 5,000 Pa·s. It should be noted that holes communicating with the cavities 2 may be provided in consideration of the reliability of reflow property.

### EXAMPLES

Next, examples are described together with comparative examples, provided that the present invention is not limited to these examples. It should be noted that, in the examples, the term “%” refers to “wt %.”

First, prior to the production of an epoxy resin composition, the following materials were prepared.

(Epoxy Resin (Component A))

Epoxy resin represented by the following chemical formula (1) (epoxy equivalent: 200, softening point: 80° C.)

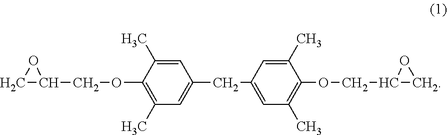 [SMILES: Cc1cc(Cc2cc(C)c(OCC3CO3)c(C)c2)cc(C)c1OCC1CO1]

(Curing Agent (Component B))

Phenol resin (MEH7851SS manufactured by Meiwa Plastic Industries, Ltd. (hydroxyl group equivalent: 203, softening point: 67° C.))

(Elastomer Component)

Polystyrene-polyisobutylene-based copolymer

(Inorganic Filler (Component C))

Spherical molten silica (FB-9454 manufactured by DENKI KAGAKU KOGYO KABUSHIKI KAISHA (average particle diameter: 20 μm))

(Curing Accelerator (Component D))

Imidazole-based compound (2PHZ-PW manufactured by SHIKOKU CHEMICALS CORPORATION)

### Example 1

The flat-plate resin sheets 1a and 1b were attached to each other in conformity with the production method 3 (stacking method) to produce a resin sheet for hollow encapsulation (see FIG. 5 and FIG. 6). That is, respective components shown in Example 1 of Table 1 below were blended at ratios shown in the table and mixed with a biaxial kneader to produce an epoxy resin composition. The composition was pressed with a pressing machine at 90° C. to produce the flat-plate resin sheet 1a having a thickness of 0.5 mm. In addition, a flat-plate resin sheet having a thickness of 0.5 mm produced in the same manner as in the flat-plate resin sheet 1a was subjected to punching processing to produce the flat-plate resin sheet 1b having angular hole portions for a plurality of cavities. Then, the resin sheets 1a and 1b were attached to each other at 50° C. to produce a resin sheet for hollow encapsulation having a plurality of cavities in one surface of a sheet main body. Then, the resin sheet for hollow encapsulation was crimped onto an aggregate substrate (slide glass) with a pressing machine. After that, the sheet was thermally cured at 150° C., followed by dicing. Thus, a hollow package was produced.

### Example 2

An epoxy resin composition was produced in the same manner as in Example 1 except that the blending ratios of the respective components were changed to ratios shown in Example 2 of Table 1 below. Then, a hollow package was produced in the same manner as in Example 1 except that the epoxy resin composition was used.

### Example 3

Respective components shown in Example 3 of Table 1 below were blended at ratios shown in the table and mixed with a biaxial kneader to produce an epoxy resin composition. The composition was pressed with a pressing machine at 90° C. to produce the flat-plate resin sheet 1a having a thickness of 0.5 mm. In addition, a pressure-sensitive adhesive formed of a composition of Example 4 of Table 1 below was applied to the surface of a flat-plate resin sheet having a thickness of 0.5 mm produced in the same manner as in the flat-plate resin sheet 1a to form a pressure-sensitive adhesion layer (having a thickness of 100 μm). Then, the resin sheet with the pressure-sensitive adhesion layer was subjected to punching processing to produce a resin sheet 1c with the pressure-sensitive adhesion layer having angular hole portions for a plurality of cavities. Next, the resin sheet 1a and the pressure-sensitive adhesion layer surface side of the resin sheet 1c were attached to each other at 50° C. to produce a resin sheet for hollow encapsulation having a plurality of cavities in one surface of a sheet main body. Then, the resin sheet for hollow encapsulation was crimped onto an aggregate substrate (slide glass) with a pressing machine. After that, the sheet was thermally cured at 150° C., followed by dicing. Thus, a hollow package was produced.

### Example 4

Respective components shown in Example 4 of Table 1 below were blended at ratios shown in the table and mixed with a biaxial kneader to produce an epoxy resin composition. The composition was pressed with a pressing machine at 90° C. to produce the flat-plate resin sheet 1a having a thickness of 0.5 mm. Then, a cover film made of a polyethylene was formed on one surface of the flat-plate resin sheet 1a. In addition, a flat-plate resin sheet having a thickness of 0.5 mm produced in the same manner as in the flat-plate resin sheet 1a was subjected to punching processing to produce the flat-plate resin sheet 1b having angular hole portions for a plurality of cavities. Then, the resin sheet 1a with the cover film and the resin sheet 1b were attached to each other at 50° C. to produce a resin sheet for hollow encapsulation having a plurality of cavities in one surface of a sheet main body. Then, the resin sheet for hollow encapsulation was crimped onto an aggregate substrate (slide glass) with a pressing machine. After that, the sheet was thermally cured at 150° C., followed by dicing. Thus, a hollow package was produced.

### Comparative Example 1

A metal cap was used instead of the resin sheet for hollow encapsulation of each of the examples. That is, a solder paste was applied between the substrate and the metal cap at the time of the placement of the cap, and then the substrate and the cap were joined to each other by crimping under heating at 260° C. Thus, a hollow package was produced.

### Comparative Example 2

A photosensitive resin was used instead of the resin sheet for hollow encapsulation of each of the examples. That is, the photosensitive resin was applied to a glass and then irradiated with UV through a mask. After that, development was performed with an aqueous solution of sodium carbonate to form a pattern. The glass having the pattern formed thereon was subjected to thermocompression bonding onto the substrate, followed by dicing. Thus, a hollow package was produced.

TABLE 1

| | | | | | Comparative | |
|---|---|---|---|---|---|---|
| | Example | | | | Example | |
| | 1 | 2 | 3 | 4 | 1 | 2 |
| Epoxy resin (A) | 4.0 | 2.8 | 1.7 | 5.1 | — | — |
| Phenol resin (B) | 4.2 | 3.0 | 1.8 | 5.4 | — | — |
| Elastomer | 3.6 | 6.0 | 8.3 | 1.2 | — | — |
| component | | | | | | |
| Spherical molten | 88.1 | 88.1 | 88.1 | 88.1 | — | — |
| silica (C) | | | | | | |
| Curing | 0.1 | 0.1 | 0.1 | 0.1 | — | — |
| accelerator (D) | | | | | | |
| Content of C in | 88.1 | 88.1 | 88.1 | 88.1 | — | — |
| epoxy resin | | | | | | |
| composition (%) | | | | | | |
| Lowest melt | 300 | 5,000 | 200,000 | 20 | — | — |
| viscosity (Pa · s) | | | | | | |
| Presence or | Absent | Absent | Present | Absent | — | — |
| absence of | | | | | | |
| pressure- | | | | | | |
| sensitive | | | | | | |
| adhesion layer | | | | | | |
| Package assembly | ◯ | ◯ | ◯ | ◯ | ◯ | ◯ |
| (bonding to | | | | | | |
| substrate) | | | | | | |
| Presence or | Absent | Absent | Absent | Present | — | — |
| absence of | | | | | | |
| cover film | | | | | | |
| Flatness of upper | ◯ | ⊚ | ⊚ | ◯ | ⊚ | ⊚ |
| portion of cavity | | | | | | |
| Productivity | ◯ | ◯ | ◯ | ◯ | X | ◯ |

| | | | |
|---|---|---|---|
| Number of steps | 3 | 1 | 5 |
| in production of | (Crimping, thermal curing, | (Join- | * |
| package | and dicing) | ing) | |

* Application, pattern formation, exposure, cap pressure curing, and dicing

The products of the examples and the products of the comparative examples thus obtained were each evaluated for respective characteristics in accordance with the following methods. Table 1 above shows the results together.

(Lowest Melt Viscosity)

The lowest melt viscosity of each of the epoxy resin compositions was determined by measuring the lowest viscosity value upon tracking of a viscosity change with a viscoelasticity-measuring apparatus ARES manufactured by TA instruments (measurement conditions: a measurement temperature range of 40 to 175° C., a rate of temperature increase of 10° C./min, and a frequency of 1 Hz).

(Flatness of Upper Portion of Cavity)

A hollow shape and the shape of the upper portion of a cavity were visually observed, and then an evaluation for the flatness of the upper portion of the cavity was performed by the following criteria.
◯: The hollow shape is maintained but the external appearance of the upper portion of the cavity deforms.
⊚: None of the hollow shape and the external appearance of the upper portion of the cavity shows deformation.
×: The hollow shape after the curing largely deforms and the external appearance of the upper portion of the cavity also largely deforms.

(Productivity)

An evaluation was performed by the following criteria.
◯: Collective hollow encapsulation was able to be made on the aggregate substrate.
×: Fixing with a cap to individual substrate is needed.

As can be seen from the results of the table, in each of the products of the examples, the flatness of the upper portion of a cavity and the productivity were good, and the number of steps in the production of the package was small. According to the products of the examples, a hollow package improved in resin strength and heat resistance can be easily produced.

Although the resin sheet for hollow encapsulation has been produced by the production method 3 (stacking method) in each of the products of the examples, when the resin sheet for hollow encapsulation is produced by the production method 1 (lamination method) or the production method 2 (pressing method), the same excellent effect as that of each of the products of the examples is obtained.

In contrast, the product of Comparative Example 1 was poor in productivity because of the following reason. The metal cap was used and hence the cap needed to be joined to the substrate individually upon its bonding to the substrate.

In addition, the product of Comparative Example 2 required steps such as the application of the photosensitive resin, the pattern formation, and the exposure, and hence the product involved a large number of steps and was poor in mass productivity.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

The resin sheet for hollow encapsulation can be suitably used in the hollow encapsulation of electronic parts that require hollow encapsulation such as MEMS and an SAW filter.

What is claimed is:

1. A resin sheet for hollow encapsulation to be used for subjecting electronic parts mounted on an aggregate substrate to hollow encapsulation, the resin sheet for hollow encapsulation comprising:
an epoxy resin composition containing the following components (A) to (D):
(A) an epoxy resin;
(B) a curing agent;
(C) an inorganic filler; and
(D) a curing accelerator,
wherein the resin sheet for hollow encapsulation has, in one surface of a sheet main body, a plurality of cavities for storing the electronic parts to subject the parts to hollow encapsulation.

2. The resin sheet for hollow encapsulation according to claim 1, wherein a content of the component (C) is 70 to 93 wt % of an entirety of the epoxy resin composition.

3. A production method for the resin sheet for hollow encapsulation according to claim 1, the method comprising:
preparing a flat-plate resin sheet formed of an epoxy resin composition containing the components (A) to (D); and
pressing the flat-plate resin sheet with a die having a convex structure for the cavities, with one of a press and a laminator.

4. A production method for the resin sheet for hollow encapsulation according to claim 2, the method comprising:
preparing a flat-plate resin sheet formed of an epoxy resin composition containing the components (A) to (D); and
pressing the flat-plate resin sheet with a die having a convex structure for the cavities, with one of a press and a laminator.

5. A production method for the resin sheet for hollow encapsulation according to claim 1, the method comprising:
preparing a first flat-plate resin sheet formed of an epoxy resin composition containing the components (A) to (D), and a second flat-plate resin sheet formed of the epoxy resin composition containing the components (A) to (D) and having hole portions for the plurality of cavities; and
attaching the first and second flat-plate resin sheets to each other.

6. A production method for the resin sheet for hollow encapsulation according to claim 2, the method comprising:
preparing a first flat-plate resin sheet formed of an epoxy resin composition containing the components (A) to (D), and a second flat-plate resin sheet formed of the epoxy resin composition containing the components (A) to (D) and having hole portions for the plurality of cavities; and
attaching the first and second flat-plate resin sheets to each other.

7. A production method for a hollow electronic part apparatus, the method comprising:
bonding the resin sheet for hollow encapsulation according to claim 1 to an aggregate substrate having electronic parts mounted on a surface thereof in a state where the electronic parts are stored in corresponding cavities;
curing the sheet; and
dicing a resultant into individual pieces including the electronic parts.

8. A production method for a hollow electronic part apparatus, the method comprising:
bonding the resin sheet for hollow encapsulation according to claim 2 to an aggregate substrate having electronic parts mounted on a surface thereof in a state where the electronic parts are stored in corresponding cavities;
curing the sheet; and
dicing a resultant into individual pieces including the electronic parts.

9. A hollow electronic part apparatus, which is obtained by the production method according to claim 7.

10. A hollow electronic part apparatus, which is obtained by the production method according to claim 8.
